(19) United States
(12) Patent Application Publication
(10) Pub. No.: US 2004/0171361 A1
(43) Pub. Date: Sep. 2, 2004

(54) Selective input level wireless receiver

(76) Inventors: Karthik Vasanth, Richardson, TX (US); Francesco Dantoni, Richardson, TX (US)

Correspondence Address: TEXAS INSTRUMENTS INCORPORATED, P O BOX 655474, M/S 3999, DALLAS, TX, 75265

(21) Appl. No.: 10/376,207

(22) Filed: Feb. 27, 2003

(51) Int. Cl. H04B 1/00

(52) U.S. Cl. 455/140; 455/130

(57) ABSTRACT

A selective power level receiver is provided that includes a selective RF switch to switch an RF signal source to either a low noise amplifier (LNA) for weak signal or an attenuator for strong signals without affecting the input and output impedance levels.

### FIELD OF INVENTION

This invention relates to wireless receivers and more particularly to providing selective input level at the wireless receiver.

### BACKGROUND OF INVENTION

Wireless local area network (WLAN) systems include for example relatively low power transceivers 11 that may be mobile and communicate with each other through relatively higher power access points or base stations 13 distributed about an area. See FIG. 1. These relatively low power transceivers 11 may be for example in PC boards in lap top computers. At these access points 13 are the transceivers with the higher power. transmitters.

The low power transceivers 11 include in the receiver front end a low noise amplifier (LNA) 15 to amplify the incoming input RF signals as illustrated in FIG. 1. The low noise amplifier 15 amplifies the input RF signal from an antenna to an acceptable level while minimizing the noise that it acts to the input signal. The output of the low noise amplifier 15 is applied to a band pass filter 17 designed to receive the frequency band of interest at a given impedance of, for example, 50 ohms. Both the input impedance to the low noise amplifier (LNA) 15 and the output impedance of the low noise amplifier (LNA) 15 are designed to be, for the example, 50 ohms. The output from the band pass filter 17 is applied to a communications processor such as a computer chip such as a DSP 19. The characteristic impedance of the band pass filter 17 depends on the filter design. The input impedance to the band pass filter depends on how the low noise amplifier (LNA) 15 is terminated. When the input impedance to the band pass filter 17 changes the filter characteristics are changed and the input signal is adversely affected.

If the received signal strength changes substantially such as when the WLAN receiver of transceiver 11 comes too close to the access point or base station 13 transmitter antenna or the base station 13 transmitted power is higher than the designed power level of the WLAN receiver such that the maximum gain is exceeded the system can be saturated. When the LNA goes into the low gain mode, it is very important to keep the input and output port impedances unchanged from the high gain mode levels (i.e. 50 ohms). Violating this affects the performance of the filters and can violate the FCC standards for reception and data can be lost.

A typical low noise amplifier (LNA) may have a pair of potentiometers to adjust the input power level but the input impedance and output impedance changes when power level exceeds the maximum gain. The LNA includes a pair of transistors with one of the transistors connected to a power supply. For gain control a second potentiometer and a third transistor is connected between the junction of the two transistors and another power supply. The third transistor is turned on and off depending on a high or low gain state. In the high gain state the third transistor is biased off and as a result there is some capacitance but the energy flows into the amplifying stage. This means that there is presented a high impedance looking into the input when the third transistor is off. When you turn this transistor on this affects the input impedance because it is physically connected to the bias condition. For example, the bias current of 3 milliamps is flowing down when it is turned off and 1 milliamp when turned on. When the bias current changes the output impedance changes and goes down to 10 ohms for example. This then creates a problem with both the band pass filter characteristics and the input impedance match. Also if the transistor is bigger or smaller this affects the low gain state.

It is therefore desirable to provide a selectable gain input receiver front end that provides a high gain for weak signals and low gain or attenuation for strong signals without affecting the input and output impedance levels.

### SUMMARY OF INVENTION

In accordance with one embodiment of the present invention the RF front end has a switch between a high gain mode state and an attenuation mode state.

### DESCRIPTION OF DRAWINGS

FIG. 1 illustrates a WLAN system and the front end of a WLAN receiver.

FIG. 2 illustrates a front end WLAN receiver according to one embodiment of the present invention.

FIG. 3 illustrates the s-parameters for high gain modes.

FIG. 4 illustrates the s-parameters for low gain or attenuation modes.

### DESCRIPTION OF PREFERRED EMBODIMENT

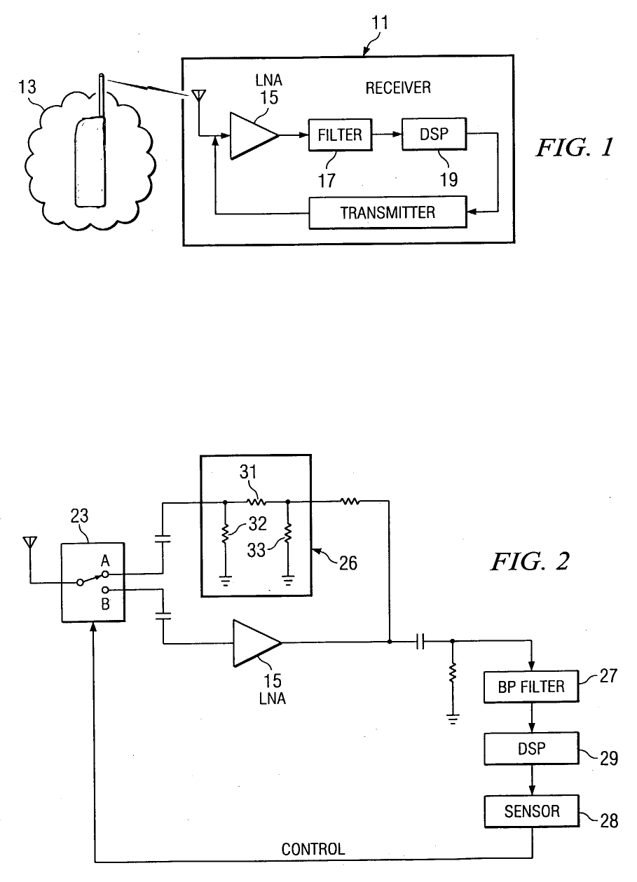

Referring to FIG. 2 there is illustrated the improved receiver system 21 with both a high gain and an attenuation mode according to one embodiment of the present invention. The input signal from the antenna is applied to an RF switch 23 that switches the input between positions A and B. Position B is connected to a low noise amplifier (LNA) 25 like in FIG. 1 to provide for the high gain to the band pass filter 27. The output of the band pass filter 27 is coupled to the communications processor such as a DSP 29.

When the switch 23 is in position A the input bypasses the low noise amplifier (LNA) 25 to the band pass filter 27. Position A is connected to a 50 ohm matched PI network attenuator 26. The PI attenuator 26 comprises series resistor 31 and shunt resistors 32 and 33. The values for these resistors to provide 50 ohm matched attenuation can be obtained from standard tables for a given level of attenuation. For 6 db of attenuation the series resistor 31 is 37.35 ohms and the shunt resistors 32 and 33 are 150.48 ohms. This table can be found in Appendix A. Both TEE and PI networks are given. The output from the matched attenuator is coupled to the band pass filter 27. For the low gain or attenuation this bypass and the RF switch 23 may be provided on a PC board. The bypass does not load the output of the amplifier and doesn't change the impedance levels. By selecting the values of resistors 31, 32 and 33 we can exactly match the attenuation desired.

The outputs from the band pass filter 27 are coupled to the communications processor 29. A power level sensor 28 continuously senses the power level at the processor input. When the power level exceeds the level for proper low noise amplifier operation, a signal from the sensor 28 operates the switch 23 to position A to cause attenuation of the input signal by the bypass network attenuator 26.

In accordance with the preferred embodiment of the present invention the switch 23 is comprised of a transistor-switching network. The coupling capacitors at the input to the attenuator and low noise amplifier isolate the DC bias of the switch and LNA.

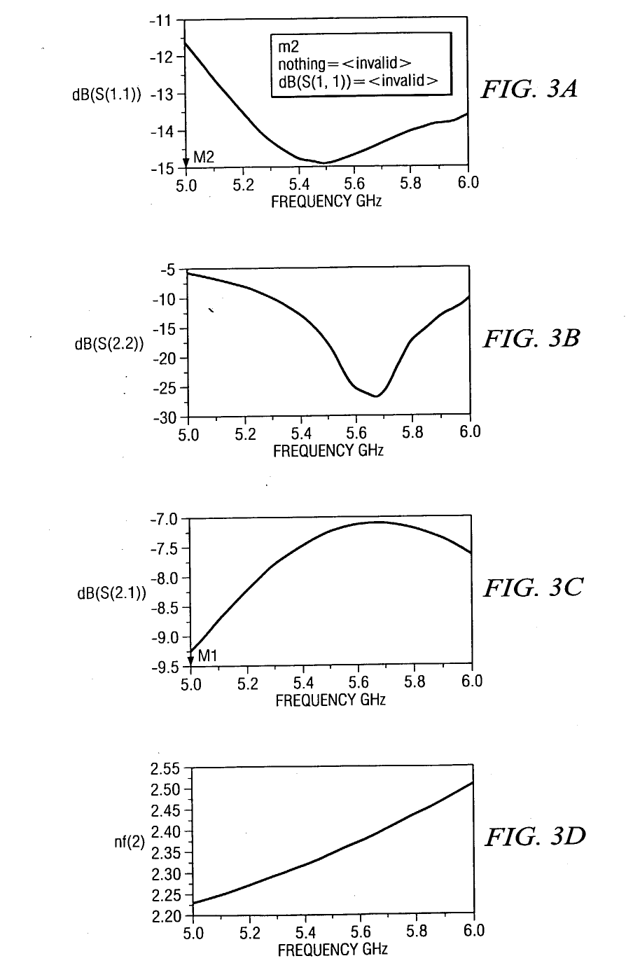

FIG. 3 illustrates the s-parameter plots for the high gain modes. FIG. 3A is a plot of s11 in db versus frequency for high gain mode. FIG. 3B is a plot of s22 in db versus frequency for high gain mode. FIG. 3C is a plot of s21 in db versus frequency for the high gain mode. FIG. 3D is a plot of noise figure versus frequency in the high gain mode.

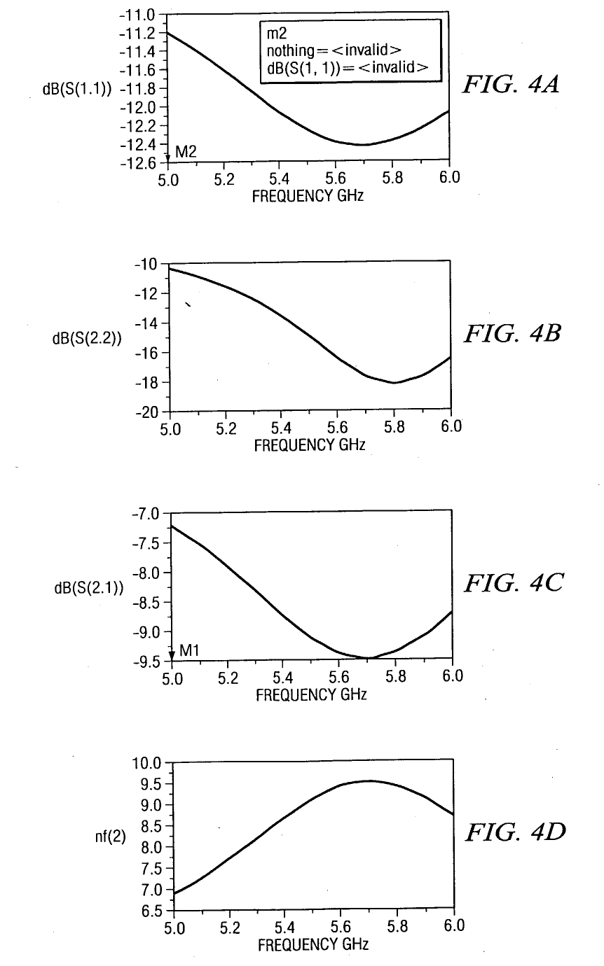

FIG. 4 illustrates the s-parameters for the low gain (attenuation) mode. FIG. 4A is a plot of s11 in db versus frequency for the low gain mode. FIG. 4B is a plot of s22 in db versus frequency for low gain mode. FIG. 4C is a plot of s21 in db versus frequency for the low gain mode. FIG. 4D is a plot of noise figure versus frequency in the low gain mode.

It can be seen that the s11 and s22 are not affected by either mode. Thus the same matching networks can be used for both modes. The low gain attenuation can easily be tuned by changing the resistor values. Further the low gain mode consumes no current because the high gain LNA is turned off during low gain mode. Another huge advantage of the passive low gain implementation is that it has very high third order compression point (IP3) and thus eases restrictions on the high input power level.

Although a specific embodiment is described in connection with a WLAN receiver this is not to be construed as limiting the scope of the invention. Other embodiments of the present invention will become apparent to those skilled in the art in light of the specification. The scope of the invention is only limited by the claims appended.

APPENDIX E
Standard Resistance Values
The standard 1% (and ½%) resistor values are recommended
for ease of design and for best availability when designing
precision analog circuits.
Standard Resistance Values for the 10-to-100 Decade
Resistance Tolerance (+ %)

| 0.1 | | |
|---|---|---|
| 0.25 | 1 | 2 |
| 0.5 | | 5 |
| 10.0 | 10.0 | 10 |
| 10.1 | — | — |
| 10.2 | 10.2 | — |
| 10.4 | — | — |
| 10.5 | 10.5 | — |
| 10.6 | — | — |
| 10.7 | 10.7 | — |
| 10.9 | — | — |
| 11.0 | 11.0 | 11 |
| 11.1 | — | — |
| 11.3 | 11.3 | — |
| 11.4 | — | — |
| 11.5 | 11.5 | — |
| 11.7 | — | — |
| 11.8 | 11.8 | — |
| 12.0 | — | 12 |
| 12.1 | 12.1 | — |
| 12.3 | — | — |
| 12.4 | 12.4 | — |
| 1.26 | — | — |
| 12.7 | 12.7 | — |
| 12.9 | — | — |
| 13.0 | 13.0 | 13 |
| 13.2 | — | — |
| 13.3 | 13.3 | — |
| 13.5 | — | — |
| 13.7 | 13.7 | — |
| 13.8 | — | — |
| 14.0 | 14.0 | — |
| 14.2 | — | — |
| 14.3 | 14.3 | — |
| 14.5 | — | — |
| 14.7 | 14.7 | — |
| 14.9 | — | — |
| 15.0 | 15.0 | 15 |
| 15.2 | — | — |
| 15.4 | 15.4 | — |
| 15.6 | — | — |
| 15.8 | 15.8 | — |
| 16.0 | — | 16 |
| 16.2 | 16.2 | — |
| 16.4 | — | — |
| 16.5 | 16.5 | — |
| 16.7 | — | — |
| 16.9 | 16.9 | — |
| 17.2 | — | — |
| 17.4 | 17.4 | — |
| 17.6 | — | — |
| 17.8 | 17.8 | — |
| 18.0 | — | 18 |
| 18.2 | 18.2 | — |
| 18.4 | — | — |
| 18.7 | 18.7 | — |
| 18.9 | — | — |
| 19.1 | 19.1 | — |
| 19.3 | — | — |
| 19.6 | 19.6 | — |
| 19.8 | — | — |
| 20.0 | 20.0 | 20 |
| 20.3 | — | — |
| 20.5 | 20.5 | — |
| 20.8 | — | — |
| 21.0 | 21.0 | — |
| 21.3 | — | — |
| 21.5 | 21.5 | — |
| 21.8 | — | — |
| 22.1 | 22.1 | 22 |
| 22.3 | — | — |
| 22.6 | 22.6 | — |
| 22.9 | — | — |
| 23.2 | 23.2 | — |
| 23.4 | — | — |
| 23.7 | 23.7 | — |
| 24.0 | — | 24 |
| 24.3 | 24.3 | — |
| 24.6 | — | — |
| 24.9 | 24.9 | — |
| 25.2 | — | — |
| 25.5 | 25.5 | — |
| 25.8 | — | — |
| 26.1 | 26.1 | — |
| 26.4 | — | — |
| 26.7 | 26.7 | — |
| 27.1 | — | 27 |
| 27.4 | 27.4 | — |
| 27.7 | — | — |
| 28.0 | 28.0 | — |
| 28.4 | — | — |
| 28.7 | 28.7 | — |
| 29.1 | — | — |
| 29.4 | 29.4 | — |
| 29.8 | — | — |
| 30.1 | 30.1 | 30 |
| 30.5 | — | — |
| 30.9 | 30.9 | — |
| 31.2 | — | — |
| 31.6 | 31.6 | — |
| 32.0 | — | — |
| 32.4 | 32.4 | — |
| 32.8 | — | — |
| 33.2 | 33.2 | 33 |
| 33.6 | — | — |
| 34.0 | 34.0 | — |
| 34.4 | — | — |
| 34.8 | 34.8 | — |
| 35.2 | — | — |
| 35.7 | 35.7 | — |
| 36.1 | — | 36 |
| 36.5 | 36.5 | — |
| 37.0 | — | — |
| 37.4 | 37.4 | — |
| 37. [symbol] | — | — |
| 38.3 | 38.3 | — |
| 38.6 | — | — |
| 39.2 | 39.2 | 39 |
| 39.7 | — | — |
| 40.2 | 40.2 | — |
| 40.7 | — | — |
| 41.2 | 41.2 | — |
| 41.7 | — | — |
| 42.2 | 42.2 | — |
| 42.7 | — | — |
| 43.2 | 43.2 | 43 |
| 43.7 | — | — |
| 44.2 | 44.2 | — |
| 44.8 | — | — |
| 45.3 | 45.3 | — |
| 45.9 | — | — |
| 46.4 | 46.4 | — |
| 47.0 | — | 47 |
| 47.5 | 47.5 | — |
| 48.1 | — | — |
| 48.7 | 48.7 | — |
| 49.3 | — | — |
| 49.9 | [symbol] | — |
| 50.5 | — | — |
| 51.1 | 51.1 | 51 |
| 51.7 | — | — |
| 52.3 | 52.3 | — |
| 53.0 | — | — |
| 53.6 | 53.6 | — |
| 54.2 | — | — |
| 54.9 | 54.9 | — |
| 56.6 | — | — |
| 56.2 | 56.2 | 56 |
| 56.9 | — | — |
| 57.6 | 57.6 | — |
| 58.3 | — | — |
| 59.0 | 59.0 | — |
| 59.7 | — | — |
| 60.4 | 60.4 | — |
| 61.2 | — | — |
| 61.9 | 61.9 | 82 |
| 62. [symbol] | — | — |
| 63.4 | 63.4 | — |
| 64.2 | — | — |
| 64.9 | 64.9 | — |
| 65.7 | — | — |
| 66.5 | 66.5 | — |
| 67.3 | — | — |
| 68.1 | 68.1 | 68 |
| 69.0 | — | — |
| 69.8 | 69.8 | — |
| 70.6 | — | — |
| 71.5 | 71.5 | — |
| 72.3 | — | — |
| 73.2 | 73.2 | — |
| 74.1 | — | — |
| 75.0 | 75.0 | 75 |
| 75.9 | — | — |
| 76.8 | 76.8 | — |
| 77.7 | — | — |
| 78.7 | 787 | — |
| 79.6 | — | — |
| 80.8 | 80.6 | — |
| 81.6 | — | — |
| 82.5 | 82.5 | 82 |
| 83.5 | — | — |
| 84.5 | 84.5 | — |
| 85.8 | — | — |
| 86.6 | 86.5 | — |
| 87.6 | — | — |
| 88.7 | 88.7 | — |
| 89.8 | — | — |
| 90.9 | 90.9 | 91 |
| 92.0 | — | — |
| 93.1 | 93.1 | — |
| 94.2 | — | — |
| 95.3 | 95.3 | — |
| 98.5 | — | — |
| 97.6 | 97.6 | — |
| 98.8 | — | — |

Standard Resistance Values are obtained from the Decade Table by multiplying by multiples of 10. As an example 12.1 can represent 1.210, 12.10, 121.0, 1210, etc.

50 Ohm Matched Attenuator

| | | |
|---|---|---|
| ATTN | TEE | PI |

| (DB) | Series | Shunt | Series | Shunt |
|---|---|---|---|---|
| 1.00 | 2.88 | 433.34 | 5.77 | 869.55 |
| 2.00 | 5.73 | 215.24 | 11.61 | 436.21 |
| 3.00 | 8.55 | 141.93 | 17.61 | 292.40 |
| 4.00 | 11.31 | 104.83 | 23.85 | 220.97 |
| 5.00 | 14.01 | 82.24 | 30.40 | 178.49 |
| 6.00 | 16.61 | 66.93 | 37.35 | 150.48 |
| 7.00 | 19.12 | 55.80 | 44.80 | 130.73 |
| 8.00 | 21.53 | 47.31 | 52.84 | 116.14 |
| 9.00 | 23.81 | 40.59 | 61.59 | 104.99 |
| 10.00 | 25.97 | 35.14 | 71.15 | 96.25 |
| 11.00 | 28.01 | 30.62 | 81.66 | 89.24 |
| 12.00 | 29.92 | 26.81 | 93.25 | 83.54 |
| 13.00 | 31.71 | 23.57 | 106.07 | 78.84 |
| 14.00 | 33.37 | 20.78 | 120.31 | 74.93 |
| 15.00 | 34.90 | 18.36 | 136.14 | 71.63 |
| 16.00 | 36.32 | 16.26 | 153.78 | 68.83 |
| 17.00 | 37.62 | 14.41 | 173.46 | 66.45 |
| 18.00 | 38.82 | 12.79 | 195.43 | 64.40 |
| 19.00 | 39.91 | 11.36 | 220.01 | 62.64 |
| 20.00 | 40.91 | 10.10 | 247.50 | 61.11 |
| 21.00 | 41.82 | 8.98 | 278.28 | 59.78 |
| 22.00 | 42.64 | 7.99 | 312.75 | 58.63 |
| 23.00 | 43.39 | 7.12 | 351.36 | 57.62 |
| 24.00 | 44.06 | 6.33 | 394.65 | 56.73 |
| 25.00 | 44.68 | 5.64 | 443.16 | 55.96 |
| 26.00 | 45.23 | 5.02 | 497.56 | 55.28 |
| 27.00 | 45.72 | 4.48 | 558.56 | 54.68 |
| 28.00 | 46.17 | 3.99 | 626.98 | 54.15 |
| 29.00 | 46.57 | 3.55 | 703.71 | 53.68 |
| 30.00 | 46.93 | 3.17 | 789.78 | 53.27 |
| 31.00 | 47.26 | 2.82 | 886.33 | 52.90 |
| 32.00 | 47.55 | 2.51 | 994.64 | 52.58 |
| 33.00 | 47.81 | 2.24 | 1116.15 | 52.29 |
| 34.00 | 48.04 | 2.00 | 1252.47 | 52.04 |
| 35.00 | 48.25 | 1.78 | 1405.41 | 51.01 |
| 36.00 | 48.44 | 1.59 | 1577.00 | 51.61 |
| 37.00 | 48.61 | 1.41 | 1769.51 | 51.43 |
| 38.00 | 48.76 | 1.26 | 1985.51 | 51.27 |
| 39.00 | 48.89 | 1.12 | 2227.85 | 51.13 |
| 40.00 | 49.01 | 1.00 | 2499.75 | 51.01 |
| 41.00 | 49.12 | .89 | 2804.82 | 50.90 |
| 42.00 | 49.21 | .79 | 3147.12 | 50.80 |
| 43.00 | 49.30 | .71 | 3531.17 | 50.71 |
| 44.00 | 49.37 | .63 | 3962.08 | 50.63 |
| 45.00 | 49.44 | .56 | 4445.56 | 50.57 |

In the claims:

1. A selective power level front end receiver comprising:
a signal amplifier for amplifying input signals to said receiver;
an attenuator for attenuating strong input signals without affecting the input and output impedance;
a switch means between an input signal reception means and said amplifier and attenuator for selectively applying said input signals to said amplifier for weak signals and said attenuator for strong signals.

2. The receiver of claim 1 wherein said switch means is responsive to input power level above a given threshold for applying said signals only to said attenuator.

3. The receiver of claim 1 wherein said switch means includes a transistor.

4. The receiver of claim 1 wherein said attenuator provides an impedance match that is the same as provided by the amplifier.

5. A selective power level front end receiver comprising:
a band pass filter operating over a band of frequencies with a given input impedance;
a low noise amplifier for amplifying input signals from a signal reception means; said amplifier providing a given impedance at the input thereof and providing an output impedance that matches said given input impedance of said band pass filter when operating over a given received input power level;
an attenuator for attenuating input signals from said signal reception means and presenting said given impedance at the input thereof and providing an output impedance that matches said given input impedance of said band pass filter; and
a switch coupled between said input signal reception means and said amplifier and said attenuator for selectively applying said input signals from said reception means to said amplifier for signals with power levels below a given power threshold level and said attenuator for signals with power levels at or above said power threshold level whereby said receiver front end provides gain for weak signals and attenuation for strong signals at or above said given threshold without affecting the input and output impedance levels.

6. The receiver of claim 5 wherein said switch means is responsive to input power level detected at the receiver at or above a given threshold for applying said signals only to said attenuator.

7. The receiver of claim 5 wherein said receiver is a WLAN receiver.

8. A method of providing selective power level at the input of a receiver wherein said receiver includes a filter providing a desired band pass characteristic when a given input impedance is present, comprising the steps of:
providing a signal amplifier for amplifying input signals to said receiver and presenting said given impedance when the input signal is below a given input power level;
providing an attenuator for matching said given impedance and attenuating input signals to said receiver when the input power levels is at or above said given power level; and
switching an input signal from said amplifier to said attenuator when the input signal level is at or above said given power level.

9. The method of claim 8 wherein said steps include detecting the power level at the output of the filter for controlling said switching.
